(19) United States
(12) Patent Application Publication
(10) Pub. No.: US 2012/0135181 A1
(43) Pub. Date: May 31, 2012

(54) SUBSTRATE STRUCTURE AND PANEL STRUCTURE

(75) Inventors: Chih-Hsiao Tseng, Hsinchu City (TW); Yan-Liang Cheng, Yilan County (TW); Yu-Chen Liu, Hsinchu City (TW)

(73) Assignee: AU OPTRONICS CORPORATION, Hsinchu (TW)

(21) Appl. No.: 13/175,889

(22) Filed: Jul. 4, 2011

(30) Foreign Application Priority Data
Nov. 25, 2010 (TW) 99140815

(51) Int. Cl. B32B 3/02

(52) U.S. Cl. 428/81

(57) ABSTRACT

A substrate structure including an upper surface, a lower surface and a plurality of side surfaces is provided. The lower surface is opposite to the upper surface. The side surfaces connect to the upper surface and the lower surface. Each side surface has a perpendicular surface, a first corner surface and a second corner surface. The perpendicular surface is perpendicular to the upper surface and the lower surface. The first corner surface is located between the perpendicular surface and the upper surface. The second corner surface is located between the perpendicular surface and the lower surface. The roughness of the first corner surface and the second corner surface are smaller than or equal to that of the perpendicular surface.

### CROSS-REFERENCE TO RELATED APPLICATION

This application claims the priority benefit of Taiwan application serial no. 99140815, filed on Nov. 25, 2010. The entirety of the above-mentioned patent application is hereby incorporated by reference herein and made a part of this specification.

### BACKGROUND OF THE INVENTION

1. Field of the Invention

The invention relates generally to a substrate structure, a panel structure, and a grinding method of a substrate edge, and more particularly to a substrate structure, a panel structure, and a grinding method of the substrate edge having a high reliability.

2. Description of Related Art

Presently, flat panel displays (e.g., liquid crystal flat panel displays, organic light emitting displays, plasma displays) have been widely applied to consumable electronic products or computer products such as medium and small portable televisions (TVs), cell phones, video cameras, notebook computers, desktop displays, and projection TVs. However, due to the demands of the market, the screen of the flat panel display has been generally trending towards large size and light weight.

In conventional techniques, the weight and the thickness of the flat panel display may be reduced by thinning a substrate of the display. Nevertheless, the bending strength of the thinned substrate is reduced, decreasing the reliability of the substrate. In particular, especially when the substrate has large dimensions, the reliability of the substrate is much lower. Therefore, during the manufacturing process of the display panel, the production yield may be reduced due to damage to the display panel caused by external forces during transport. Accordingly, how to strengthen the thinned substrate has become a major challenge to solve in manufacturing techniques of the display panel.

### SUMMARY OF THE INVENTION

The invention provides a substrate structure having a high reliability and adaptable for subsequent processing.

The invention provides a panel structure having a high reliability.

The invention provides a substrate structure, including an upper surface, a lower surface, and a plurality of side surfaces. The lower surface corresponds to the upper surface. The side surfaces are connected to the upper surface and the lower surface. Each of the side surfaces has a perpendicular surface, a first corner surface, and a second corner surface. The perpendicular surface is perpendicular to the upper surface and the lower surface. The first corner surface is located between the perpendicular surface and the upper surface. The second corner surface is located between the perpendicular surface and the lower surface. The roughness of the first corner surface and the second corner surface are smaller than or equal to the roughness of perpendicular surface.

The invention provides a substrate structure, including an upper surface, a lower surface, and a plurality of side surfaces. The lower surface corresponds to the upper surface. The side surfaces are connected to the upper surface and the lower surface. Each of the side surfaces has a perpendicular surface, a first corner surface, and a second corner surface. The perpendicular surface is perpendicular to the upper surface and the lower surface. The first corner surface is located between the perpendicular surface and the upper surface. The second corner surface is located between the perpendicular surface and the lower surface. The first corner surface includes at least two first sub-corner surfaces. The second corner surface includes at least two second sub-corner surfaces.

The invention provides a panel structure, including a first substrate, a second substrate, and a sealant. The first substrate has an upper surface and a plurality of first side surfaces. Each of the first side surfaces has a first perpendicular surface and a first corner surface. The first perpendicular surface is perpendicular to the upper surface. The first corner surface is located between the first perpendicular surface and the upper surface. The roughness of the first corner surface is smaller than or equal to the roughness of the first perpendicular surface. The second substrate has a lower surface and a plurality of second side surfaces. The lower surface corresponds to the upper surface. Each of the second side surfaces has a second perpendicular surface and a second corner surface. The second perpendicular surface is perpendicular to the lower surface. The second corner surface is located between the second perpendicular surface and the lower surface. The roughness of the second corner surface is smaller than or equal to the roughness of the second perpendicular surface. The sealant is disposed between the first substrate and the second substrate. A distance between the first perpendicular surface and the sealant is between 0 mm and 1 mm. A distance between the second perpendicular surface and the sealant is between 0 mm and 1 mm.

The invention provides a panel structure, including a first substrate, a second substrate, and a sealant. The first substrate has an upper surface and a plurality of first side surfaces. Each of the first side surfaces has a first perpendicular surface and a first corner surface. The first perpendicular surface is perpendicular to the upper surface. The first corner surface is located between the first perpendicular surface and the upper surface. The first corner surface includes at least two first sub-corner surfaces. The second substrate has a lower surface and a plurality of second side surfaces. The lower surface corresponds to the upper surface. Each of the second side surfaces has a second perpendicular surface and a second corner surface. The second perpendicular surface is perpendicular to the lower surface. The second corner surface is located between the second perpendicular surface and the lower surface. The second corner surface includes at least two second sub-corner surfaces. The sealant is disposed between the first substrate and the second substrate. A distance between the first perpendicular surface and the sealant is between 0 mm and 1 mm. A distance between the second perpendicular surface and the sealant is between 0 mm and 1 mm.

In summary, according to an embodiment of the invention, since the roughness of the first corner surface and the second corner surface are smaller than or equal to the roughness of the perpendicular surface, the reliability of the substrate structures can be enhanced by structurally strengthening the side surfaces of the substrate structures. Accordingly, damage incurred during the process, transport, or manufacture of the substrate structures due to the inadequate strength of the substrate structures can be effectively mitigated.

In order to make the aforementioned and other features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A is a schematic perspective view of a substrate structure according to an embodiment of the invention.

FIG. 1B is a partial schematic side view of the substrate structure depicted in FIG. 1A.

FIG. 1C is a partial schematic side view of a substrate structure according to another embodiment of the invention.

FIG. 2A is a schematic perspective view of a panel structure according to an embodiment of the invention.

FIG. 2B is a partial schematic side view of the panel structure depicted in FIG. 2A.

FIG. 2C is a partial schematic side view of a panel structure according to another embodiment of the invention.

FIGS. 3A to 3D are schematic views illustrating the steps for a grinding method of a substrate edge according to an embodiment of the invention.

FIG. 4 is a partial schematic side view of a panel structure according to another embodiment of the invention.

FIGS. 5A to 5C are schematic views illustrating the steps for a grinding method of a substrate edge according to another embodiment of the invention.

FIG. 6 is a partial schematic side view of a panel structure according to another embodiment of the invention.

### DESCRIPTION OF EMBODIMENTS

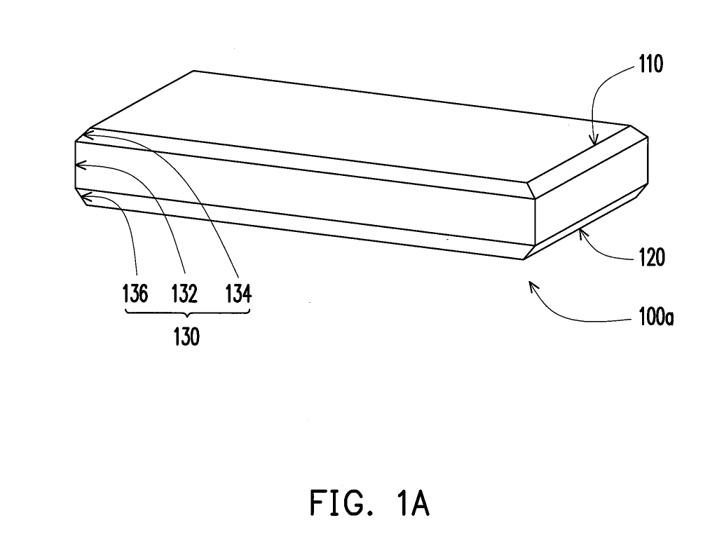

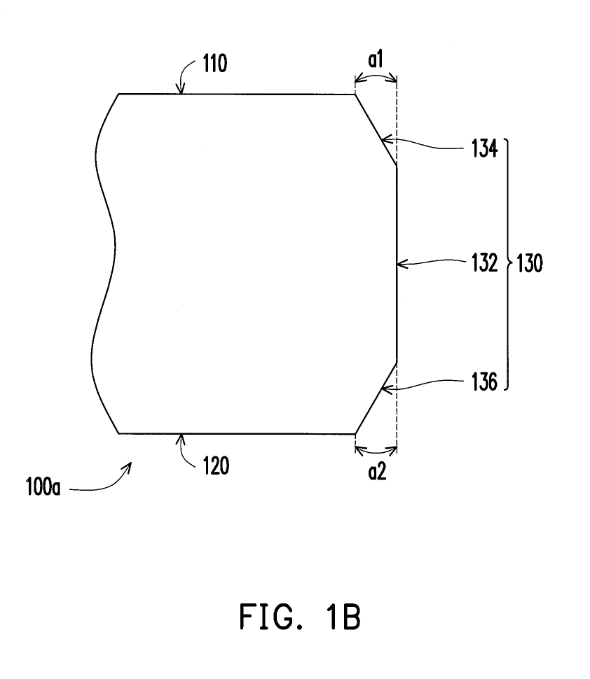

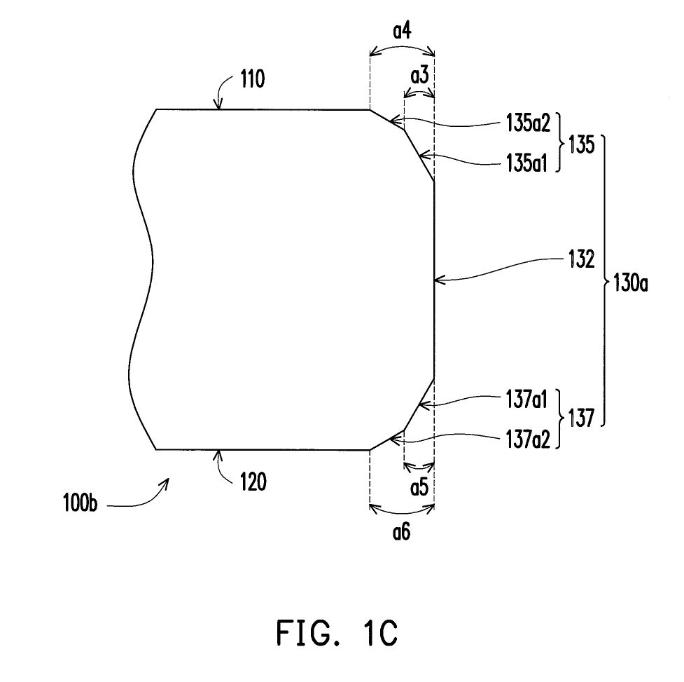

FIG. 1A is a schematic perspective view of a substrate structure according to an embodiment of the invention. FIG. 1B is a partial schematic side view of the substrate structure depicted in FIG. 1A. Referring to FIGS. 1A and 1B, in the present embodiment, a substrate structure 100a includes an upper surface 110, a lower surface 120, and a plurality of side surfaces 130.

More specifically, the lower surface 120 is opposite to the upper surface 110. The side surfaces 130 are connected to the upper surface 110 and the lower surface 120. Each of the side surfaces 130 has a perpendicular surface 132, a first corner surface 134, and a second corner surface 136. The perpendicular surface 132 is perpendicular to the upper surface 110 and the lower surface 120. The first corner surface 134 is located between the perpendicular surface 132 and the upper surface 110, and the second corner surface 136 is located between the perpendicular surface 132 and the lower surface 120. Specifically, the roughness of the first corner surface 134 and the second corner surface 136 are smaller than the roughness of perpendicular surface 132.

Particularly, in the present embodiment, an average center line roughness Ra of the perpendicular surface 132 is between 0.04 and 0.1, and a full roughness height Ry of the perpendicular surface 132 is between 0.5 and 0.93. An average center line roughness Ra of the first corner surface 134 and the second corner surface 136 is between 0.001 and 0.04, and a full roughness height Ry of the first corner surface 134 and the second corner surface is between 0.1 and 0.5.

Moreover, in the present embodiment, a first included angle a1 is formed between the first corner surface 134 and an extended surface of the perpendicular surface 132. A second included angle a2 is formed between the second corner surface 136 and an extended surface of the perpendicular surface 132. The first included angle a1 and the second included angle a2 are, for example, between 30° and 80°. Preferably, the first included angle a1 and the second included angle a2 are between 40° and 70°.

It should be noted that, the invention is not limited to the aforementioned structures of the side surfaces 130. Although each of the afore-described side surfaces 130 is specifically formed by a perpendicular surface 132, a first corner surface 134, and a second corner surface 136, but other known structural designs capable of strengthening the substrate structure 100a still fall within the technical schemes adopted by the invention without departing from the scope of the invention.

For example, FIG. 1C is a partial schematic side view of a substrate structure according to another embodiment of the invention. Referring to FIGS. 1B and 1C, in the present embodiment, a substrate structure 100b of FIG. 1C is similar to the substrate structure 100a of FIG. 1B. A difference therebetween is a first corner surface 135 of the side surfaces 130a of the substrate structure 100b includes at least two first sub-corner surfaces connected to each other (e.g., the two first sub-corner surfaces 135a1 and 135a2 schematically depicted in FIG. 1C). Moreover, a second corner surface 137 includes at least two second sub-corner surfaces connected to each other (e.g., the two second sub-corner surfaces 137a1 and 137a2 schematically depicted in FIG. 1C).

More specifically, in the present embodiment, the roughness of the first sub-corner surfaces 135a1 and 135a2 and the second sub-corner surfaces 137a1 and 137a2 are smaller than or equal to the roughness of the perpendicular surface 132. The average center line roughness Ra of the perpendicular surface 132 is between 0.04 and 0.1, and the full roughness height Ry of the perpendicular surface 132 is between 0.5 and 0.93. Alternatively, the average center line roughness Ra of the perpendicular surface 132 is between 0.001 and 0.04, and the full roughness height Ry of the perpendicular surface 132 is between 0.1 and 0.5. That is, the perpendicular surface 132 is a mirror surface, for example. The average roughness of the first sub-corner surfaces 135a1 and 135a2 and the second sub-corner surfaces 137a1 and 137a2 are between 0.001 and 0.04, and the full roughness height Ry of the first sub-corner surfaces 135a1 and 135a2 and the second sub-corner surfaces 137a1 and 137a2 is between 0.1 and 0.5. Namely, the first sub-corner surfaces 135a1 and 135a2 and the second sub-corner surfaces 137a1 and 137a2 are, for example, mirror surfaces.

Further, an included angle a3 is formed between the first sub-corner surface 135a1 and the extended surface of the perpendicular surface 132. An included angle a4 is formed between an extended surface of the first sub-corner surface 135a2 and the extended surface of the perpendicular surface 132. The included angle a4 is larger than the included angle a3, and the included angle a3 and the included angle a4 are, for example, respectively between 30° and 80°. Preferably, the included angle a3 and the included angle a4 are respectively between 40° and 70°. An included angle a5 is formed between the second sub-corner surface 137a1 and the extended surface of the perpendicular surface 132. An included angle a6 is formed between an extended surface of the second sub-corner surface 137a2 and the extended surface of the perpendicular surface 132. The included angle a6 is larger than the included angle a5, and the included angle a5 and the included angle a6 are, for example, respectively between 30° and 80°. Preferably, the included angle a5 and the included angle a6 are respectively between 40° and 70°.

According to the present embodiment, since the roughness of the first corner surfaces 134 and 135 and the second corner surfaces 136 and 137 are smaller than the roughness of the perpendicular surface 132, the side surfaces 130 and 130a of the substrate structures 100a and 100b are structurally strengthened, thereby enhancing the reliability of the substrate structures 100a and 100b. Accordingly, damage incurred during the process, transport, or manufacture of the substrate structures 100a and 100b due to the inadequate strength of the substrate structures 100a and 100b can be effectively mitigated.

Moreover, the substrate structures 100a and 100b may also be applied in a panel structure for display, in which the panel structure may be a liquid crystal display panel, e.g., a transmissive display panel, a transflective display panel, a reflective display panel, a color-filter-on-array display panel, an array-on-color-filter display panel, a VA display panel, an IPS display panel, a MVA display panel, a TN display panel, a STN display panel, a PVA display panel, a S-PVA display panel, an ASV display panel, a FFS display panel, a CPA display panel, an ASM display panel, an OCB display panel, an S-IPS display panel, an AS-IPS display panel, an UFFS display panel, a PSA display panel, a dual-view display panel, a triple-view display panel, a three-dimensional display panel, other display panels, or a combination of the above.

Furthermore, the panel structure may also be an electro-luminescent panel structure, e.g., a fluorescent electro-luminescent display panel, a phosphor electro-luminescent display panel, or a combination thereof. Here, an electro-luminescent material of the electro-luminescent display panel includes an organic material, an inorganic material, or a combination thereof. In addition, molecules of the electro-luminescent material include small molecules, polymers, or a combination thereof.

Two different embodiments are provided below to further elaborate the designs of the substrate structures 100a and 100b applied in a panel structure for display.

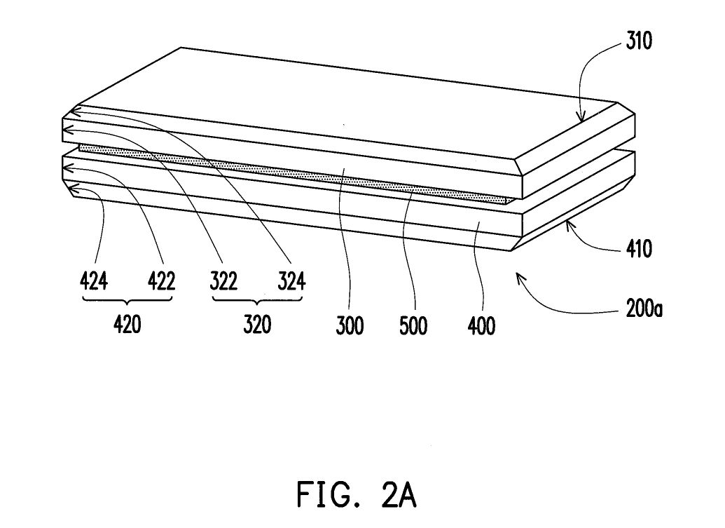

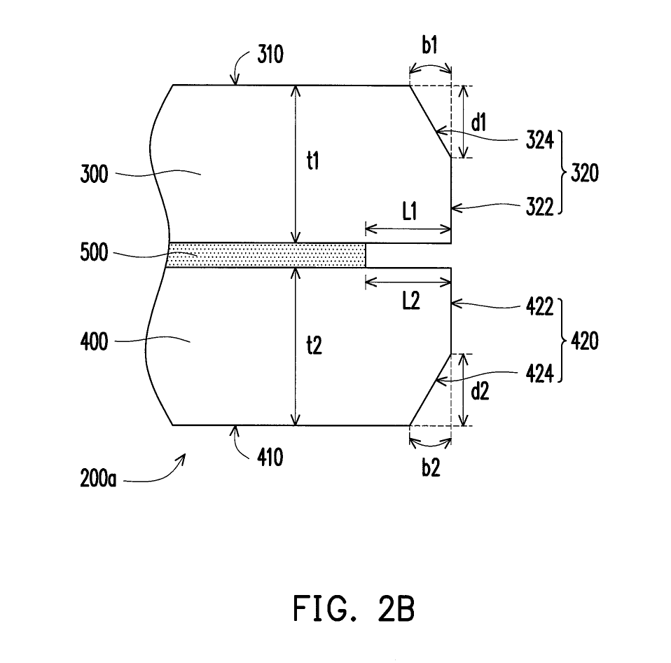

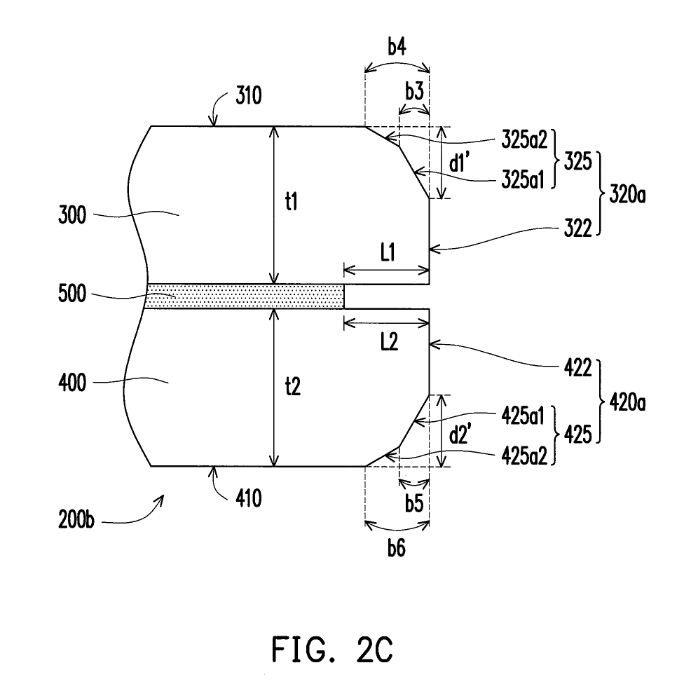

FIG. 2A is a schematic perspective view of a panel structure according to an embodiment of the invention. FIG. 2B is a partial schematic side view of the panel structure depicted in FIG. 2A. Referring to FIGS. 2A and 2B, in the present embodiment, a panel structure 200a includes a first substrate 300, a second substrate 400, and a sealant 500.

Specifically, the first substrate 300 has an upper surface 310 and a plurality of first side surfaces 320. Each of the first side surfaces 320 has a first perpendicular surface 322 and a first corner surface 324. The first perpendicular surface 322 is perpendicular to the upper surface 310. The first corner surface 324 is located between the first perpendicular surface 322 and the upper surface 310, and the roughness of the first corner surface 324 is smaller than the roughness of the first perpendicular surface 322. The second substrate 400 has a lower surface 410 corresponding to the upper surface 310, and a plurality of second side surfaces 420. Each of the second side surfaces 420 has a second perpendicular surface 422 and a second corner surface 424, in which the second perpendicular surface 422 is perpendicular to the lower surface 410. The second corner surface 424 is located between the second perpendicular surface 422 and the lower surface 410, and the roughness of the second corner surface 424 is smaller than or equal to the roughness of the second perpendicular surface 422. The sealant 500 is disposed between an edge of the first substrate 300 and an edge of the second substrate 400. A distance L1 between the first perpendicular surface 322 and an outer edge of the sealant 500 is, for example, between 0 mm and 1 mm. In addition, a distance L2 between the second perpendicular surface 422 and the outer edge of the sealant 500 is, for example, between 0 mm and 1 mm.

More specifically, in the present embodiment, an average center line roughness Ra of the first perpendicular surface 322 and the second perpendicular surface 422 is between 0.04 and 0.1, and a full roughness height Ry of the first perpendicular surface 322 and the second perpendicular surface 422 is between 0.5 and 0.93. Alternatively, the average center line roughness Ra of the first perpendicular surface 322 and the second perpendicular surface 422 is between 0.001 and 0.04, and the full roughness height Ry of the first perpendicular surface 322 and the second perpendicular surface 422 is between 0.1 and 0.5. That is to say, the first perpendicular surface 322 and the second perpendicular surface 422 are, for example, mirror surfaces. The average center line roughness Ra of the first corner surface 324 and the second corner surface 424 are between 0.001 and 0.04, and a full roughness height Ry of the first corner surface 324 and the second corner surface 424 is between 0.1 and 0.5. Namely, the first corner surface 324 and the second corner surface 424 are, for example, mirror surfaces.

Moreover, a first included angle b1 is formed between the first corner surface 324 and an extended surface of the first perpendicular surface 322. A second included angle b2 is formed between the second corner surface 424 and an extended surface of the second perpendicular surface 422. The first included angle b1 and the second included angle b2 are, for example, between 30° and 80°. Preferably, the first included angle b1 and the second included angle b2 are between 40° and 70°.

Specifically, in the present embodiment, for a connecting area between the first corner surface 324 and the first perpendicular surface 322, a perpendicular distance between the connecting area and the upper surface 310 is d1. Moreover, since a thickness of the first substrate 300 is t1, d1=0.1*t1˜0.5*t1. Preferably, d1=0.1*t1˜0.2*t1. Moreover, for a connecting area between the second corner surface 424 and the second perpendicular surface 422, a perpendicular distance between the connecting area and the lower surface 310 is d2. Moreover, since a thickness of the second substrate 400 is t2, d2=0.1*t2˜0.5*t2. Preferably, d2=0.1*t1˜0.2*t1.

However, the present embodiment does not limit the structure of the first side surface 320 and the second side surface 420. Although the aforementioned first side surface 320 is specifically formed by a first perpendicular surface 322 and a first corner surface 324, and the second side surface 420 is specifically formed by a second perpendicular surface 422 and a second corner surface 424, but other known structural designs capable of strengthening the first side surface 310 and the second side surface 420 of the panel structure 200a still fall within the technical schemes adopted by the invention without departing from the scope of the invention.

For example, FIG. 2C is a partial schematic side view of a panel structure according to another embodiment of the invention. Referring to FIGS. 2B and 2C, in the present embodiment, a panel structure 200b of FIG. 2C is similar to the panel structure 200a of FIG. 2B. A difference therebetween is a first corner surface 325 of the panel structure 200b of FIG. 2C includes at least two first sub-corner surfaces (e.g., the two first sub-corner surfaces 325a1 and 325a2 schematically depicted in FIG. 2C). Moreover, a second corner surface 425 includes at least two second sub-corner surfaces (e.g., the two second sub-corner surfaces 425a1 and 425a2 schematically depicted in FIG. 2C).

More specifically, in the present embodiment, the roughness of the first sub-corner surfaces 325a1 and 325a2 and the second sub-corner surfaces 425a1 and 425a2 are smaller than or equal to the roughness of the first perpendicular surface 322 and the second perpendicular surface 422. The average center line roughness Ra of the first perpendicular surface 322 and the second perpendicular surface 422 is between 0.04 and 0.1, and the full roughness height Ry of the first perpendicular surface 322 and the second perpendicular surface 422 is between 0.5 and 0.93. The average center line roughness Ra of the first sub-corner surfaces 325a1 and 325a2 and the second sub-corner surfaces 425a1 and 425a2 are between 0.001 and 0.4, and the full roughness height Ry of the first sub-corner surfaces 325a1 and 325a2 and the second sub-corner surfaces 425a1 and 425a2 is between 0.1 and 0.5.

Further, an included angle b3 is formed between the first sub-corner surface 325a1 and the extended surface of the perpendicular surface 322. An included angle b4 is formed between an extended surface of the first sub-corner surface 325a2 and the extended surface of the perpendicular surface 322. The included angle b4 is larger than the included angle b3, and the included angle b3 and the included angle b4 are, for example, respectively between 30° and 80°. Preferably, the included angle b3 and the included angle b4 are respectively between 40° and 70°. An included angle b5 is formed between the second sub-corner surface 425a1 and the extended surface of the second perpendicular surface 422. An included angle b6 is formed between an extended surface of the second sub-corner surface 425a2 and the extended surface of the second perpendicular surface 422. The included angle b6 is larger than the included angle b5, and the included angle b5 and the included angle b6 are, for example, respectively between 30° and 80°. Preferably, the included angle b5 and the included angle b6 are respectively between 40° and 70°.

In the present embodiment, since the roughness of the first corner surfaces 324 and 325 and the second corner surfaces 424 and 425 are smaller than the roughness of the first perpendicular surface 322 and the second perpendicular surface 422, the first side surfaces 320 and 320a of the panel structures 200a and 200b are structurally strengthened, thereby enhancing the reliability of the panel structures 200a and 200b. Accordingly, damage incurred during the transport of the panel structures 200a and 200b due to the inadequate strength of the panel structures 200a and 200b can be effectively mitigated.

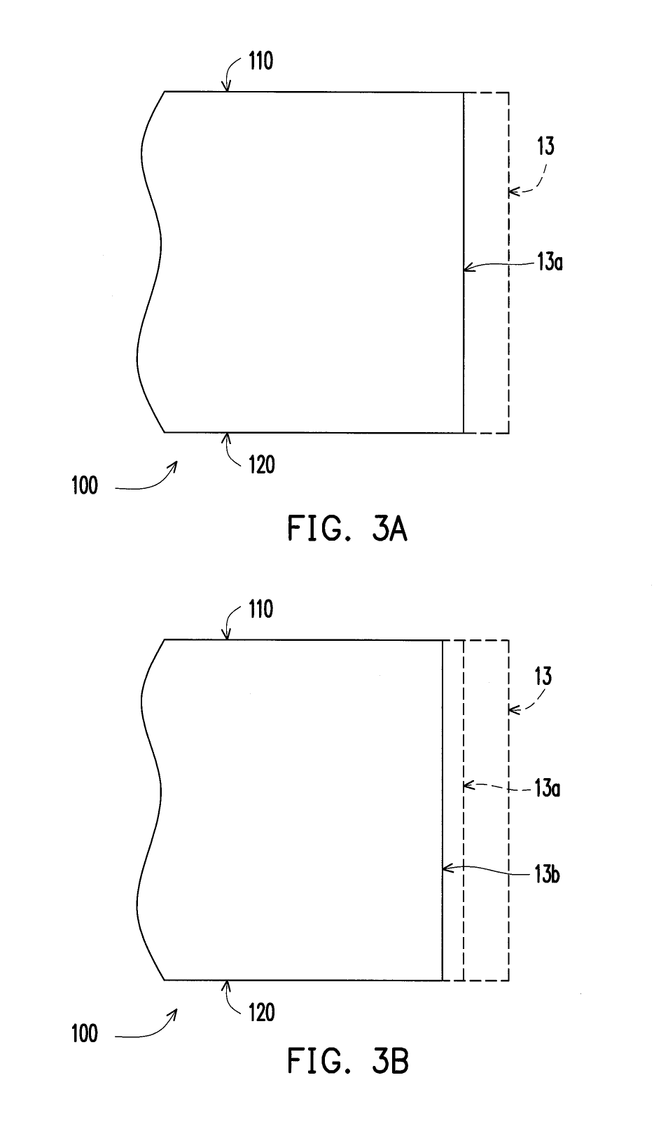

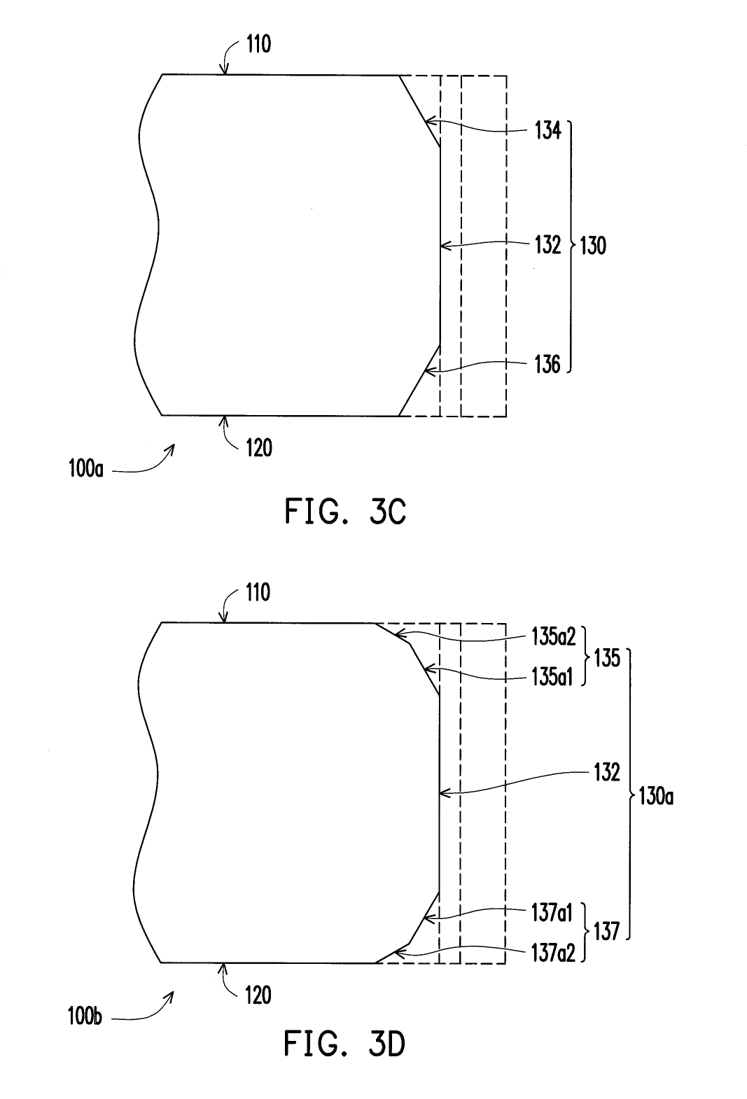

Along with FIGS. 3A to 3D, an embodiment is provided below to describe in detail a grinding method of a substrate edge. It should be noted that, in the embodiment described below, element labels and portions of the previous embodiments are referenced hereafter, and the same or similar elements are indicated by the same or similar reference labels. The descriptions of the same technical details are therefore not repeated here. The parts omitted from description may be referenced from the afore-described embodiments and are not repeated in the embodiment below.

FIGS. 3A to 3D are schematic views illustrating the steps for a grinding method of a substrate edge according to an embodiment of the invention. The grinding method of the substrate edge in the present embodiment includes following steps. First, referring to FIG. 3A, a substrate structure 100 having an upper surface 110, a lower surface, and a plurality of side surfaces 13 is provided.

Next, referring again to FIG. 3A, a rough grinding process is performed on the side surfaces 13 to thin a thickness of the side surfaces 13, so as to form a plurality of side surfaces 13a. In the present embodiment, a grindstone of #500˜1000 is used for the rough grinding process.

Thereafter, referring to FIG. 3B, a fine grinding process is performed on the side surfaces 13a to treat the thinned side surfaces 13a, so as to form a plurality of side surfaces 13b. In the present embodiment, a grindstone of #1000˜2000 is used for the fine grinding process.

Referring next to FIG. 3C, a first corner grinding process is performed on the side surfaces 13b, so as to form a plurality of side surfaces 130. In the present embodiment, each of the side surfaces 130 has a perpendicular surface 132, a first corner surface 134, and a second corner surface 136. The first corner surface 134 is located between the perpendicular surface 132 and the upper surface 110, and the second corner surface 136 is located between the perpendicular surface 132 and the lower surface 120. Moreover, the roughness of the first corner surface 134 and the second corner surface 136 is smaller than the roughness of the perpendicular surface 132. In addition, a grindstone of #2000˜6000 is used for the first corner grinding process, so the first corner surface 134 and the second corner surface 136 are, for example, mirror surfaces. Thus far, the fabrication of the substrate structure 100a is substantially complete.

Nevertheless, after completing the first corner grinding process, a second corner grinding process may be performed on the side surfaces 130 of the substrate structure 100a, so as to form a plurality of side surfaces 130a as shown FIG. 3D. In the present embodiment, each of the first corner surfaces 135 has at least two first sub-corner surfaces 135a1 and 135a2, and each of the second corner surfaces 137 has at least two second sub-corner surfaces 137a1 and 137a2. In addition, a grindstone of #2000˜6000 is used for the second corner grinding process, so the first corner surface 135 and the second corner surface 137 are, for example, minor surfaces. Thus far, the fabrication of the substrate structure 100b is substantially complete.

Since the substrate structures 100a and 100b fabricated by the grinding method of the substrate edge according the present embodiment undergo at least two grinding processes (including the rough and fine grinding processes), and at least one corner grinding process, therefore the roughness of the first corner surfaces 134 and 135 and the second corner surfaces 136 and 137 are smaller than or equal to the roughness of the perpendicular surface 132. Accordingly, the side surfaces 130 and 130a can be structurally strengthened, thereby enhancing the reliability of the substrate structures 100a and 100b. Specifically, a conventional substrate structure can withstand approximately 130 MPa in a stress test, whereas the substrate structures 100a and 100b can withstand approximately 250 MPa in a stress test. In other words, the substrate structures 100a and 100b of the present embodiment can enhance the reliability by approximately 100%.

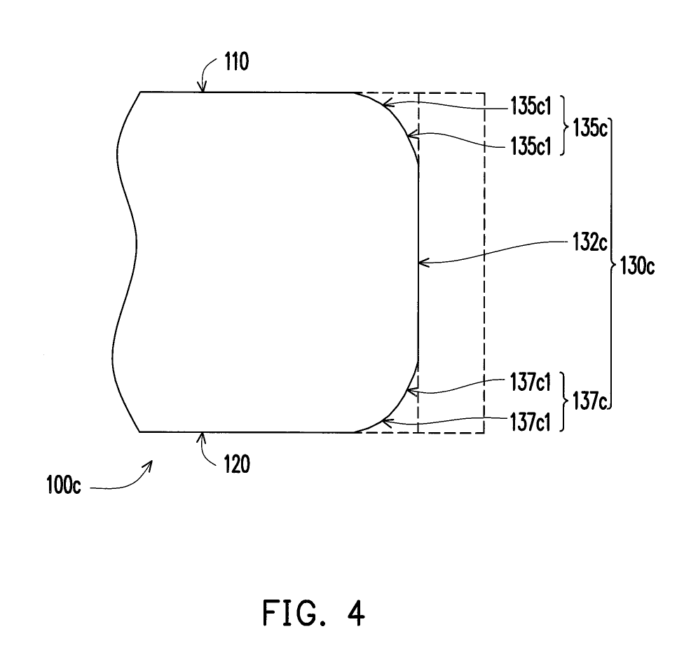

FIG. 4 is a partial schematic side view of a panel structure according to another embodiment of the invention. Referring to FIGS. 3D and 4, in the present embodiment, a substrate structure 100c of FIG. 4 is similar to the substrate structure 100b of FIG. 3D. A difference therebetween is a first corner surface 135c on a side surface 130c of the substrate structure 100c is formed by more than two first sub-corner surfaces 135c1. Moreover, a second corner surface 137c is formed more than two second sub-corner surfaces 137c1. Since the boundary between the first sub-corner surfaces 135c1 is not well-defined, the first corner surface 135c may be viewed as an arc mirror surface. Likewise, since the boundary between the second sub-corner surfaces 137c1 is not well-defined, the second corner surface 137c may be viewed as an arc mirror surface.

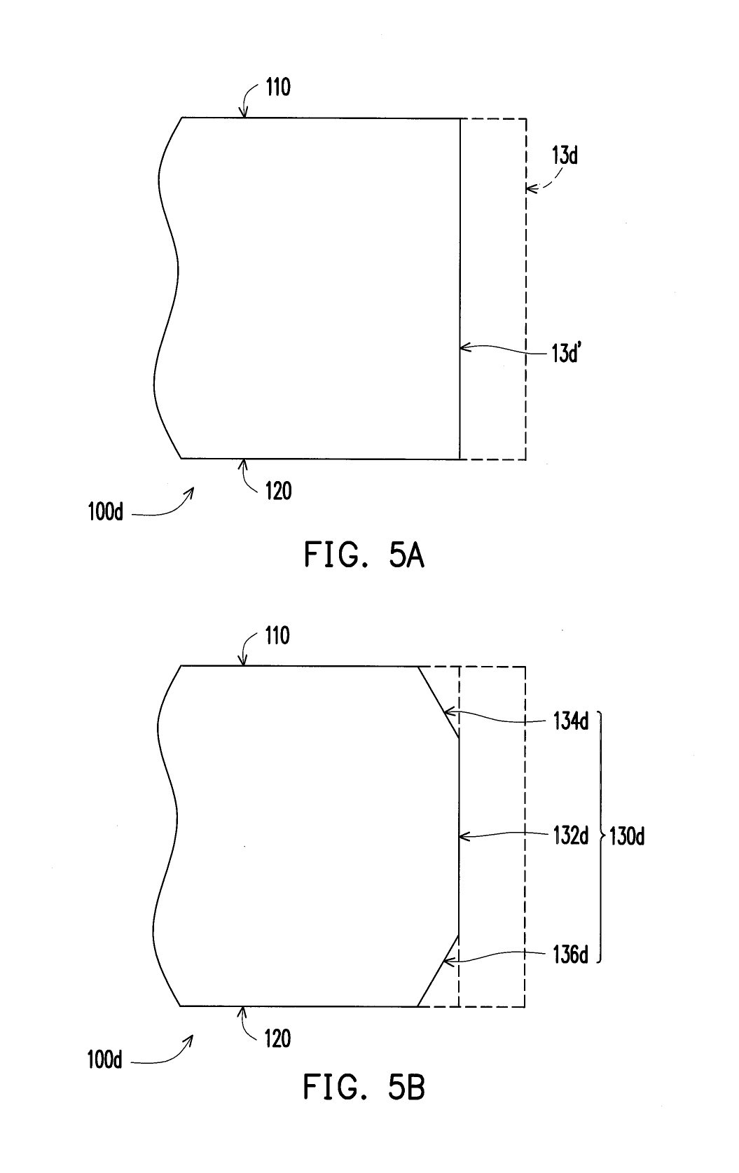

FIGS. 5A to 5C are schematic views illustrating the steps for a grinding method of a substrate edge according to another embodiment of the invention. In the present embodiment, the grinding method of the substrate edge of FIGS. 5A to 5C is similar to the grinding method of the substrate edge of FIGS. 3A to 3D. A difference therebetween is that FIG. 5A first provides a substrate structure 100d, then laser cutting is employed to replace the rough and fine grinding processes depicted in FIGS. 3A and 3B to treat a side surface 13d, so as to form a plurality of side surfaces 13d′. Here, the side surfaces 13d′ formed by laser cutting are, for example, mirror surfaces.

Thereafter, referring next to FIG. 5B, a first corner grinding process is performed on the side surfaces 13d′, so as to form a plurality of side surfaces 130d. In the present embodiment, each of the side surfaces 130d has a perpendicular surface 132d, a first corner surface 134d, and a second corner surface 136d. The first corner surface 134d is located between the perpendicular surface 132d and the upper surface 110, and the second corner surface 136d is located between the perpendicular surface 132d and the lower surface 120. Moreover, the roughness of the first corner surface 134d and the second corner surface 136d are smaller than the roughness of the perpendicular surface 132d. In the present embodiment, since the side surfaces 130d are formed by laser cutting, therefore the perpendicular surface 132d may be viewed as a mirror surface. In addition, a grindstone of #2000˜6000 is used for the first corner grinding process, so the first corner surface 134d and the second corner surface 136d are, for example, mirror surfaces. Thus far, the fabrication of the substrate structure 100d is substantially complete.

Nevertheless, after completing the first corner grinding process, a second corner grinding process may be performed on the side surfaces 130d of the substrate structure 100d, so as to form a plurality of side surfaces 130d′ as shown FIG. 5C. In the present embodiment, each of the first corner surfaces 135d has at least two first sub-corner surfaces 135d1 and 135d2, and each of the second corner surfaces 137d has at least two second sub-corner surfaces 137d1 and 137d2. In addition, a grindstone of #2000˜6000 is used for the second corner grinding process, so the first corner surface 135d and the second corner surface 137d are, for example, mirror surfaces. Thus far, the fabrication of the substrate structure 100d′ is substantially complete.

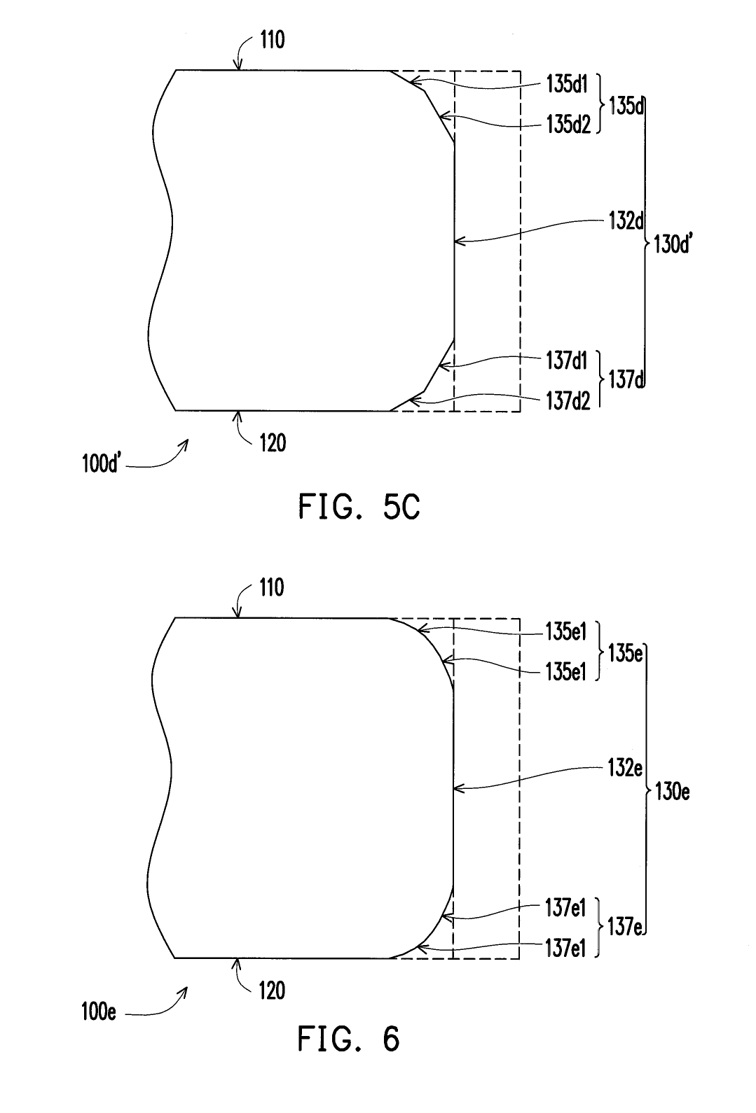

FIG. 6 is a partial schematic side view of a panel structure according to another embodiment of the invention. Referring to FIGS. 5C and 6, in the present embodiment, a substrate structure 100e of FIG. 6 is similar to the substrate structure 100d′ of FIG. 5C. A difference therebetween is a first corner surface 135e on a side surface 130e of the substrate structure 100e is formed by more than two first sub-corner surfaces 135e1. Moreover, a second corner surface 137e is formed by more than two second sub-corner surfaces 137e1. Since the boundary between the first sub-corner surfaces 135e1 is not obvious, the first corner surface 135e may be viewed as an arc mirror surface. Likewise, since the boundary between the second sub-corner surfaces 137e1 is not obvious, the second corner surface 137e may be viewed as an arc mirror surface.

In view of the foregoing, according to an embodiment of the invention, since the roughness of the first corner surface and the second corner surface are smaller than or equal to the roughness of the perpendicular surface 132, the side surfaces of the substrate structures are structurally strengthened, thereby enhancing the reliability of the substrate structures. Accordingly, damage incurred during the process, transport, or manufacture of the substrate structures due to the inadequate strength of the substrate structures can be effectively mitigated. Moreover, according to an embodiment, the panel structures manufactured by processing the substrate structures have high reliability. Further, by fabricating substrate structures using the grinding method of the substrate edge according to an embodiment of the invention, the side surfaces have structurally strengthened side surfaces. Therefore, the substrate structures have high reliability.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A substrate structure, comprising:
an upper surface;
a lower surface opposite to the upper surface; and
a plurality of side surfaces connected to the upper surface and the lower surface, each of the side surfaces having a perpendicular surface perpendicular to the upper surface and the lower surface, a first corner surface located between the perpendicular surface and the upper surface, and a second corner surface located between the perpendicular surface and the lower surface;
wherein, the roughness of the first corner surface and the second corner surface are smaller than or equal to the roughness of the perpendicular surface.

2. The substrate structure as claimed in claim 1, wherein the perpendicular surface has an average center line roughness Ra between 0.04 and 0.1 and a full roughness height Ry between 0.5 and 0.93, or the perpendicular surface has the average center line roughness Ra between 0.001 and 0.04 and the full roughness height Ry between 0.1 and 0.5.

3. The substrate structure as claimed in claim 1, wherein the first corner surface and the second corner surface have an average center line roughness Ra between 0.001 and 0.4 and a full roughness height Ry between 0.1 and 0.5.

4. The substrate structure as claimed in claim 1, wherein a first included angle is formed between the first corner surface and an extended surface of the perpendicular surface, a second included angle is formed between the second corner surface and an extended surface of the perpendicular surface, and the first included angle and the second included angle are between 30° and 80°.

5. The substrate structure as claimed in claim 1, wherein the first corner surface comprises at least two first sub-corner surfaces, and the second corner surface comprises at least two second sub-corner surfaces.

6. The substrate structure as claimed in claim 5, wherein an included angle between 30° and 80° is formed between each of the first sub-corner surfaces and an extended surface of the perpendicular surface, and an included angle between 30° and 80° is formed between each of the second sub-corner surfaces and an extended surface of the perpendicular surface.

7. A panel structure, comprising:
a first substrate having an upper surface and a plurality of first side surfaces, wherein each of the first side surfaces has a first perpendicular surface perpendicular to the upper surface and a first corner surface located between the first perpendicular surface and the upper surface, and the roughness of the first corner surface is smaller than or equal to the roughness of the first perpendicular surface;
a second substrate having a lower surface and a plurality of second side surfaces, wherein the lower surface corresponds to the upper surface, each of the second side surfaces has a second perpendicular surface perpendicular to the lower surface and a second corner surface located between the second perpendicular surface and the lower surface, and the roughness of the second corner surface is smaller than or equal to the roughness of the second perpendicular surface; and
a sealant disposed between the first substrate and the second substrate, wherein a distance between the first perpendicular surface and the sealant is between 0 mm and 1 mm, and a distance between the second perpendicular surface and the sealant is between 0 mm and 1 mm.

8. The panel structure as claimed in claim 7, wherein the first perpendicular surface and the second perpendicular surface have an average center line roughness Ra between 0.04 and 0.1 and a full roughness height Ry is between 0.5 and 0.93, or the first perpendicular surface and the second perpendicular surface have the average center line roughness Ra between 0.001 and 0.04 and the full roughness height Ry 0.1 and 0.5.

9. The panel structure as claimed in claim 7, wherein the first corner surface and the second corner surface have an average center line roughness Ra between 0.001 and 0.4 and a full roughness height Ry between 0.1 and 0.5.

10. The panel structure as claimed in claim 7, wherein a first included angle is formed between the first corner surface and an extended surface of the first perpendicular surface, a second included angle is formed between the second corner surface and an extended surface of the second perpendicular surface, and the first included angle and the second included angle are between 30° and 80°.

11. The panel structure as claimed in claim 7, wherein
a perpendicular distance between a connecting area and the upper surface is d1, wherein the connecting area is between the first corner surface and the first perpendicular surface, a thickness of the first substrate is t1, and d1=0.1*t1˜0.5*t1; and
a perpendicular distance between a connecting area and the lower surface is d2, wherein the connecting area is between the second corner surface and the second perpendicular surface, a thickness of the second substrate is t2, and d2=0.1*t2˜0.5*t2.

12. A panel structure, comprising:
a first substrate having an upper surface and a plurality of first side surfaces, wherein each of the first side surfaces has a first perpendicular surface perpendicular to the upper surface and a first corner surface located between the first perpendicular surface and the upper surface, and the first corner surface comprises at least two first sub-corner surfaces;
a second substrate having a lower surface and a plurality of second side surfaces, wherein the lower surface corresponds to the upper surface, each of the second side surfaces has a second perpendicular surface perpendicular to the lower surface and a second corner surface located between the second perpendicular surface and the lower surface, and the second corner surface comprises at least two second sub-corner surfaces; and
a sealant disposed between the first substrate and the second substrate, wherein a distance between the first perpendicular surface and the sealant is between 0 mm and 1 mm, and a distance between the second perpendicular surface and the sealant is between 0 mm and 1 mm.
